(19) United States
(12) Patent Application Publication
(10) Pub. No.: US 2005/0226516 A1
(43) Pub. Date: Oct. 13, 2005

(54) Image dictionary creating apparatus and method

(75) Inventors: Shunichi Kimura, Kanagawa (JP); Yutaka Koshi, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/067,899

(22) Filed: Mar. 1, 2005

(30) Foreign Application Priority Data
Apr. 12, 2004 (JP) 2004-116648

(51) Int. Cl. G06K 9/36

(52) U.S. Cl. 382/243

(57) ABSTRACT

An image dictionary creating apparatus includes: an information obtaining unit that obtains results of character recognition processing for an input image; a character string selection unit that selects character strings adjacent to each other in the input image based on the results of character recognition obtained by the information obtaining unit; a typical pattern determining unit that determines typical image patterns composing the input image on the basis of the images of character strings selected by the character string selection unit; and an identification information assigning unit that assigns the respective determined image patterns determined by the typical pattern determining unit with identification information for identifying image patterns.

### BACKGROUND OF THE INVENTION

1. Field of the Invention

The present invention relates to a coding apparatus which creates an image dictionary which associates image patterns composing an input image and identification information of the image patterns with each other and applies the created image dictionary to coding process.

2. Background Art

For example, it is known to provide an image recording apparatus which receives an input of image data containing a first image composed of photographic images and graphics and a second image composed of characters, detects the second image area in this image information, and extracts and records the second image area from the image information. With this apparatus, characters within the area of the second image can be converted into character codes, recorded, and used as a keyword for retrieval. It is also known to provide a character area coding method in which a font database common for the coding side and the decoding side is prepared and character codes and font types are coded.

### SUMMARY OF THE INVENTION

The present invention was made in view of the above-mentioned background, and an object thereof is to provide a coding apparatus which creates an image dictionary for realizing high coding efficiency and carries out coding by applying this image dictionary.

The invention provides an image dictionary creating apparatus, including: an information obtaining unit that obtains results of character recognition processing for an input image; a character string selection unit that selects character strings adjacent to each other in the input image based on the results of character recognition obtained by the information obtaining unit; a typical pattern determining unit that determines typical image patterns composing the input image on the basis of the images of character strings selected by the character string selection unit; and an identification information assigning unit that assigns the respective determined image patterns determined by the typical pattern determining unit with identification information for identifying image patterns.

The invention provides a coding apparatus, including: a replacement unit that replaces character images or character string images with identification information and character area information, the character images or character string images contained in an input image, the identification information corresponding to the character images or the character string images, the character area information showing areas of the character images or the character string images, on the basis of an image dictionary which associates the character images and character string images contained in the input image and the identification information; a code outputting unit that outputs the identification information, the character area information replaced by the replacement unit and the image dictionary.

The invention provides a computer readable medium configured to store a data file, the data file including: first image dictionary data containing data on character images each corresponding to a single character and first identification information for identifying this character image, the data on character images and the first identification information associated with each other; second image dictionary data containing data on character string images corresponding to character strings and second identification information for identifying the character string images, the data on character string images and the second identification information associated with each other; and coded data containing positions of occurrence of the character images or the character string images in the whole image and identification information corresponding to the character images or the character string images, the positions and the identification information associated with each other.

The invention provides an image dictionary creating method, including: obtaining results of character recognition processing for an input image; selecting character strings adjacent to each other in the input image based on the obtained results of character recognition; determining typical image patterns composing the input image based on the selected character string images; and assigning identification information for identifying image patterns to the determined image patterns.

The invention provides a computer readable medium configured to store a set of instructions for operating a computer in an image dictionary creating apparatus, the instructions including: obtaining results of character recognition processing for an input image; selecting character strings adjacent to each other in the input image based on the obtained results of character recognition; determining typical image patterns composing the input image based on images of the selected character strings; and providing the determined image patterns with identification information for identifying image patterns.

### BRIEF DESCRIPTION OF THE DRAWINGS

Embodiments of the present invention will be described in detail based on the following figures, wherein:

FIG. 1A is an explanatory diagram of a coding method on the premise that a common font database exists.

FIG. 1B is an explanatory diagram of a coding method on the premise that an image dictionary is attached.

FIG. 2A is an explanatory diagram illustrating an image dictionary.

FIGS. 2B and 2C are explanatory diagrams illustrating units of image patterns to be registered on the image dictionary.

FIG. 3 is a block diagram illustrating a hardware configuration of an image processing apparatus mainly including a control device, the hard ware configuration in which an image dictionary creating method of the invention is applied.

FIG. 4 is a block diagram showing a functional construction of a coding program that is executed by the control device and that realizes the image dictionary creating method of the invention.

FIG. 5 is a block diagram to explain functions of the image dictionary creating portion in greater detail.

FIG. 6 is a block diagram to explain functions of the coding portion in greater detail.

FIG. 7 is a flowchart showing operations of the coding program.

FIG. 8 is a flowchart describing the single-character corresponding image pattern determination processing in greater detail.

FIG. 9 is a flowchart describing the character string corresponding image pattern determination processing in greater detail.

FIG. 10A is an explanatory diagram illustrating an image dictionary of character images (single character).

FIG. 10B is an explanatory diagram illustrating character string candidates and appearance frequencies.

FIG. 10C is an explanatory diagram illustrating an image dictionary of character string images created based on the character string candidates.

FIG. 11 is a flowchart explaining coding processing in greater detail.

FIG. 12 is an explanatory diagram illustrating an image dictionary created for each accuracy of character recognition.

### DETAILED DESCRIPTION OF THE PREFERRED EMBODIMENTS

First, for understanding of the invention, the background and outline thereof are described.

For example, an image processing apparatus 2 can realize a high compression rate by coding identification information and positions of occurrence of character images instead of coding of the character images themselves contained in an input image.

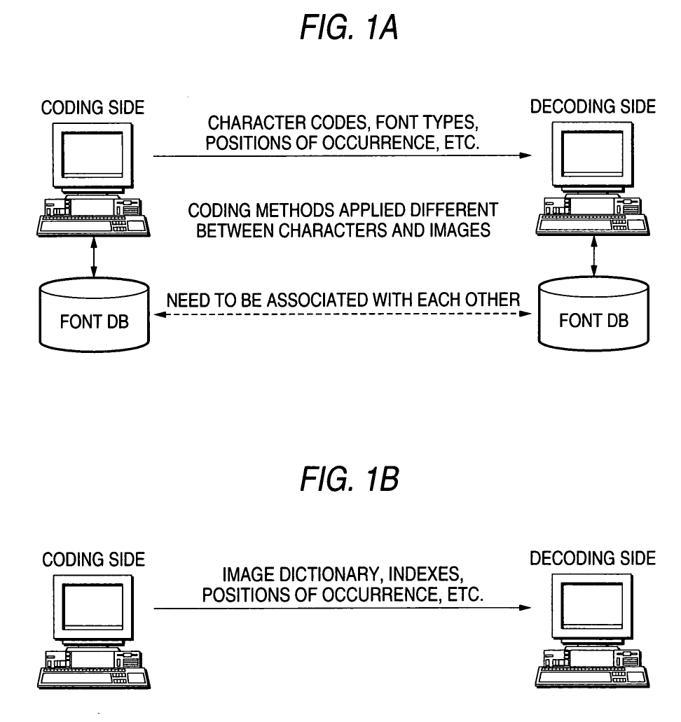

FIG. 1A describes a coding method on the assumption that a common font database is available, and FIG. 1B describes a coding method on the premise of provision of an image dictionary.

As shown in FIG. 1A, when a common font database storing character images by associating these with identification information (character codes and font types) exists on both a coding side and an decoding side, an image processing apparatus on the coding side can transmit image data to an image processing apparatus on the decoding side with a high compression rate by coding identification information on the character images (character codes and font types) and positions of occurrence of character images. In this case, the image processing apparatus on the decoding side decodes received coded data (character codes, font types, and positions of occurrence) and generates character images on the basis of the decoded character codes, font types, and positions of occurrence, and font images registered on the font database.

However, in the coding method on the premise of the existence of the font database, the font database must be provided for the coding side and the decoding side, respectively, and the font databases bear the burden on the storage area. When the font database on the coding side is updated, the font database on the decoding side must also be updated so as to have the same contents as those on the coding side. Furthermore, this cannot sufficiently cope with handwritten characters since a handwritten character is replaced with a font image and this lowers reproducibility, and a handwritten character is handled as a non-character image and the code amount cannot be reduced.

Therefore, as shown in FIG. 1B, on the decoding side, the image processing apparatus 2 in this embodiment registers typical image patterns contained in an input image by associating these with indexes, and replaces image patterns contained in the input image with corresponding indexes and positions of occurrence to code these. On the coding side, image dictionary containing image patterns and indexes associated with each other, coded indexes, and positions of occurrence to the decoding side. On the decoding side, indexes and positions of occurrence are decoded and image patterns corresponding to the decoded indexes are selected from the image dictionary and arranged at the decoded positions of occurrence.

Thus, the image processing apparatus 2 realizes a high compression rate without the premise of a common database by creating and transmitting or receiving an image dictionary according to an input image. It is not necessary that the font database is synchronized between the coding side and the decoding side. Furthermore, the code amount can be reduced while maintaining sufficient reproducibility for handwritten characters. To reduce the code amount, it is desirable that the image dictionary is also coded.

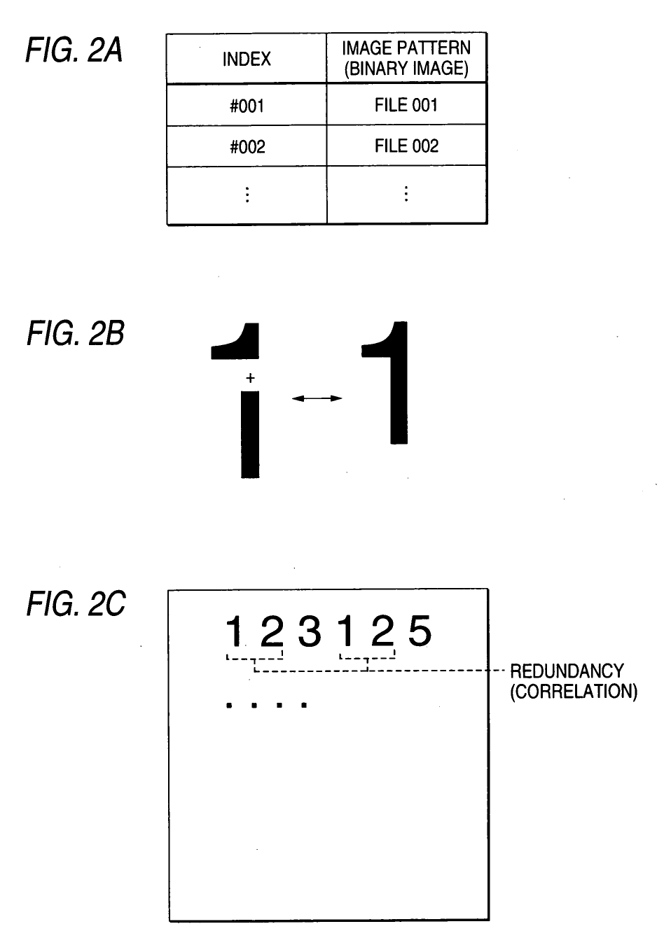

FIG. 2A illustrates an image dictionary, and FIG. 2B and FIG. 2C illustrate image pattern units.

As illustrated in FIG. 2A, the image dictionary contains a plurality of image patterns contained in an input image and indexes assigned for identifying the image patterns. The image pattern is local image data contained in the input image, and in this example, it is a stereotyped pattern (binary data) appearing a predetermined number of times or more (a plurality of times) in the input image (binary). The index is identification information generated for each input image, and may be a serial number assigned for an image pattern in order of extracting image patterns from the input image.

Next, it becomes an issue what standards will be applied to extraction and registration of image patterns from an input image as an image dictionary. Depending on the sizes and appearance frequencies of the extracted image patterns, the code amount of the input image differs. For example, as illustrated in FIG. 2B, a case where image patterns are extracted in units of character images and a case where image patterns are extracted in units smaller than the character images are considered.

In most cases where image patterns are extracted in units smaller than the character images, the appearance frequencies of the image patterns become high (for example, the vertical bar portion of “1” appears as a part of “L” and “J” and the number of image patterns to be registered on the image dictionary increases, resulting in a large amount of data of the image dictionary.

On the other hand, when image patterns are extracted in units of character images, many characters with the same font type and the same font size in the same language appear, so that high appearance frequencies can be expected although the sizes of the image patterns are large.

Furthermore, to obtain a high compression rate by allowing a certain level of irreversibility, an image processing apparatus on the coding side replaces and codes not only the same partial images as the image patterns but also partial images similar to the image patterns with indexes. In this case, if the components of a character image are replaced with similar image patterns, there is a possibility that these are decoded into a completely different image as a whole character image and readability is lost. However, when image patterns are extracted in units of character images, the whole form of a character image is replaced with a similar image pattern (for example, numeral “1” and alphabet “I,” etc.), and a certain level of readability is maintained.

Therefore, the image processing apparatus 2 of this embodiment extracts image patterns in units of character images from an input image and registers these on an image dictionary.

Furthermore, as illustrated in FIG. 2C, within the same page or same document, in many cases, not only the character sizes and font types but also character spacing included in character strings are almost constant. Furthermore, in many cases, high correlativity exists among character strings contained in the input image. Therefore, by registering images of character strings (hereinafter, referred to as character string images) on an image dictionary as single image patterns, a high compression rate is realized.

Therefore, the image processing apparatus 2 of this embodiment extracts image patterns in units of character string images from an input image and registers these on an image dictionary. The character string in this embodiment means a combination of a plurality of characters.

Next, the hardware configuration of the image processing apparatus 2 is described.

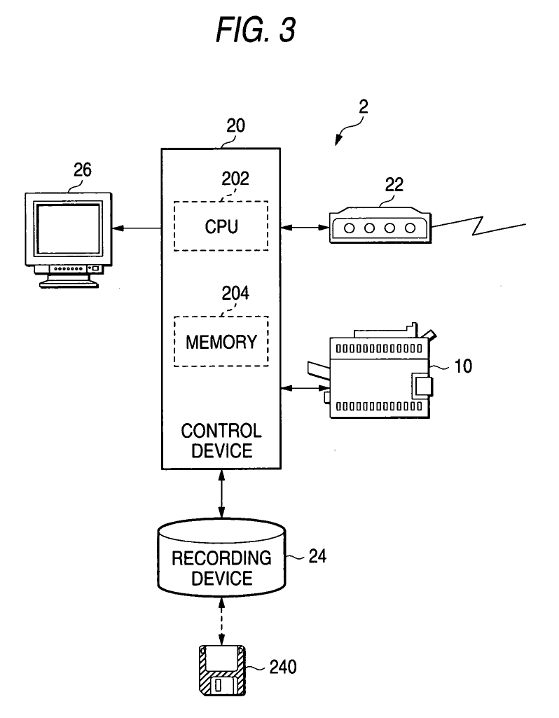

FIG. 3 illustrates the hardware configuration of the image processing apparatus 2 to which an image dictionary creating method according to the invention is applied, centered on the control device 20.

As illustrated in FIG. 3, the image processing apparatus 2 includes a control device 20 including a CPU 202 and a memory 204, etc., a communications device 22, a storage device 24 such as a HDD/CD device, and a user interface device (UI device) including a LCD display or a CRT display and a keyboard and a touch panel, etc.

The image processing apparatus 2 is, for example, a general-purpose computer with a coding program 5 (described later) installed as a part of a printer driver, which obtains image data via the communications device 22 or the storage device 24, codes the obtained image data, and transmits the data to the printer 10. The image processing apparatus 2 obtains image data optically read by a scanner function of the printer 10 and codes the obtained image data.

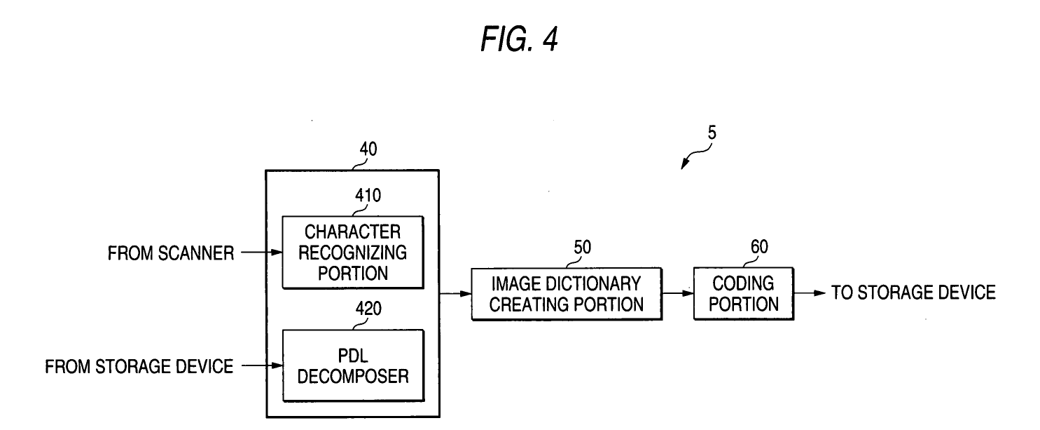

FIG. 4 illustrates the functional construction of the coding program 5 that is executed by the control device 20 (FIG. 3) to realize the image dictionary creating method of the invention.

As illustrated in FIG. 4, the coding program 5 has an image input portion 40, an image dictionary creating portion 50, and a coding portion 60.

In the coding program 5, the image input portion 40 (an information obtaining unit) obtains image data read by the scanner function of the printer 10 or image data in PDL (Page Description Language) obtained via the communications device 22 or the storage device 24, and converts the obtained image data into raster data and outputs it to the image dictionary creating portion 50. The image input portion 40 has a character recognizing portion 410 for recognizing character images from optically read image data or the like, and a PDL decomposer 420 for generating raster data by interpreting image data in PDL.

The character recognizing portion 410 recognizes characters contained in inputted image data (hereinafter, referred to as an input image) and outputs character identification information of recognized characters and character area information of the recognized characters as the results of character recognition processing to the image dictionary creating portion 50. Herein, the character identification information is data for identifying characters, and is, for example, general-purpose character codes (ASCII codes or shift JIS codes, etc.) or combinations of character codes and font types. The character area information is data showing the areas of character images in the input image, and is layout information on characters containing, for example, the character image positions, sizes, and ranges, or combinations of these.

The PDL decomposer 420 generates image data (raster data) rasterized by interpreting the image data in PDL, and outputs character identification information and character area information on character images of the generated image data to the image dictionary creating portion 50 together with the generated image data.

The image dictionary creating portion 50 creates an image dictionary to be used for coding an input image based on the input image inputted from the image input portion 40 and outputs the created image dictionary and the input image to the coding portion 60. Concretely, the image dictionary creating portion 50 extracts image patterns in units of character images and units of character string images from the input image based on the character identification information and character area information inputted from the character recognizing portion 410 or the PDL decomposer 420, and assigns indexes to the extracted image patterns to create an image dictionary and outputs these to the coding portion 60.

The coding portion 60 codes the input image based on the image dictionary inputted from the image dictionary creating portion 50, and outputs the coded input image and the image dictionary to the storage device 24 (FIG. 3) or the printer 10 (FIG. 3). In detail, the coding portion 60 compares the image patterns registered on the image dictionary and partial images contained in the input image and replaces data on the partial images coincident or similar to any of the image patterns with indexes corresponding to the image patterns and position information of the partial images. Furthermore, the coding portion 60 may code the indexes and position information replaced with the partial images and the image dictionary by means of entropy coding (Huffman coding, arithmetic coding, or LZ coding).

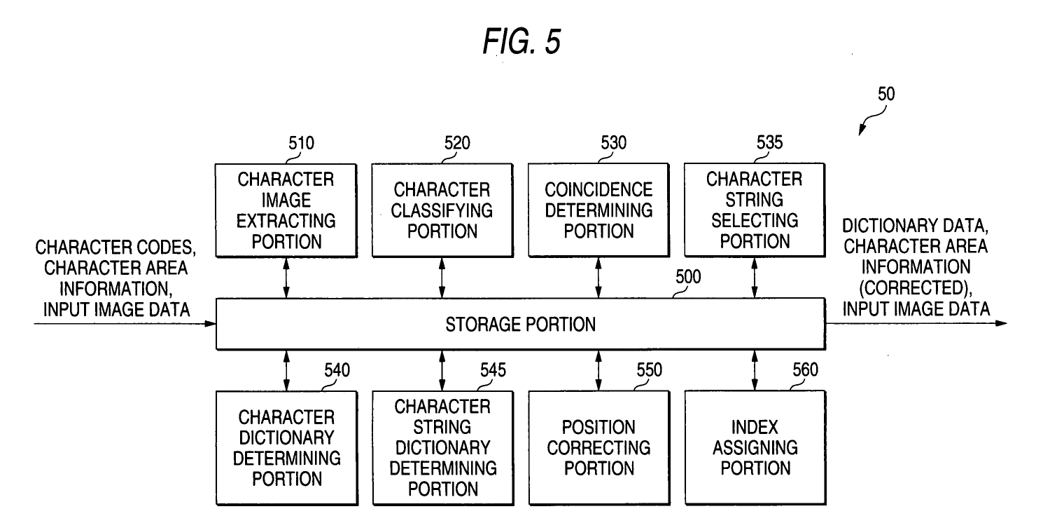

FIG. 5 describes the functions of the image dictionary creating portion 50 in greater detail.

As shown in FIG. 5, the image dictionary creating portion 50 includes a storage portion 500 (a pattern storage unit), a character image extracting portion 510, a character classifying portion 520, a coincidence determining portion 530, a character string selecting portion 535, a character dictionary determining portion 540, a character string dictionary determining portion 545 (a typical pattern determining unit), a position correcting portion 550, and an index assigning portion (an identification information assigning unit). The storage portion 500 controls the memory 204 (FIG. 3) and the storage device 24 (FIG. 3) to store an input image inputted from the image input portion 40 (FIG. 4), character identification information and character area information. Hereinafter, character codes are described as a detailed example of the character identification information and character position information is described as a detailed example of the character area information.

The character image extracting portion 510 cuts character images out of an input image based on character position information. Namely, the character image extracting portion 510 extracts areas shown by the character area information as character images from the input image. The extracted character images are areas determined as character images by the character recognizing portion 410. The character recognizing portion 410 or the PDL decomposer 420 may output the character images cut out of the input image to the image dictionary creating portion 50.

The character classifying portion 520 classifies character images cut out of the input image into a plurality of character image groups based on the character codes. For example, the character classifying portion 520 classifies character images with the identical character codes into the same character image group.

The coincidence determining portion 530 compares the plurality of character images cut out of the input image and determines the level of coincidence. Herein, the level of coincidence is data showing the level of coincidence among the plurality of images with each other, and means, for example, in comparison of binary images with each other, when two character images are overlapped with each other, the number of pixels overlapping each other (hereinafter, referred to as coinciding pixel number), the coinciding pixel rate obtained by normalizing this coinciding pixel number (for example, the number of coinciding pixels divided by the total number of pixels), pixel distribution (histogram) when the plurality of character images are overlapped with each other, and the like.

The coincidence determining portion 530 determines the level of coincidence by comparing the plurality of character images at a plurality of relative positions. Namely, the coincidence determining portion 530 compares the plurality of character images while shifting these from each other to calculate the highest level of coincidence.

For example, the coincidence determining portion 530 calculates a coinciding pixel rate while shifting two character images (character images with character codes identical to each other) classified into the same character image group from each other, and outputs a highest value of the coinciding pixel rate and a shifting vector with which the highest value is obtained to the storage portion 500.

The character string selecting portion 535 selects character strings to be registered on the image dictionary as image patterns based on character codes. In detail, the character string selecting portion 535 selects combinations of characters adjacent to each other as character string candidates based on the character codes of character images contained in the input image, calculates the appearance frequencies of the selected character string candidates, and selects character strings to be registered on the image dictionary according to the calculated appearance frequencies. The character string selecting portion 535 calculates the appearance frequencies of character string candidates by setting a page, document, or job as a unit, and determines character strings to be registered on the image dictionary for each page, document, or job.

The character dictionary determining portion 540 determines image patterns (each corresponding to a single character) to be registered on the image dictionary based on the character images contained in each character image group. Namely, the character dictionary determining portion 540 determines image patterns to be registered based on the plurality of character images with character codes identical to each other. For example, the character dictionary determining portion 540 defines a sum coupling pattern of the plurality of character images with character codes identical to each other (position-corrected character images described later) as an image pattern to be registered. The sum coupling pattern is the form of the union of the plurality of images overlapped with each other.

The character string dictionary determining portion 545 creates images (character images) of the character strings selected by the character string selecting portion 535, and registers the created character string images as image patterns on the image dictionary. In detail, the character string dictionary determining portion 545 selects images (character images) of characters composing the character strings selected by the character string selecting portion 535 from the image patterns of character images determined by the character dictionary determining portion 540, and composites the selected image patterns to create character string images.

The position correcting portion 550 corrects position information on the character images based on the shifting vector outputted from the coincidence determining portion 530. Namely, the position correcting portion 550 corrects the position information inputted from the image input portion 40 so that the level of coincidence of the plurality of character images with character codes identical to each other becomes highest.

The index assigning portion 560 provides the image patterns determined based on the input image with indexes for identifying image patterns, and outputs the assigned indexes to the storage portion 500 by associating the indexes with the image patterns. The index assigning portion 560 provides different indexes for an image pattern corresponding to a single character determined by the character dictionary determining portion 540 and an image pattern corresponding to a character string determined by the character string dictionary determining portion 545.

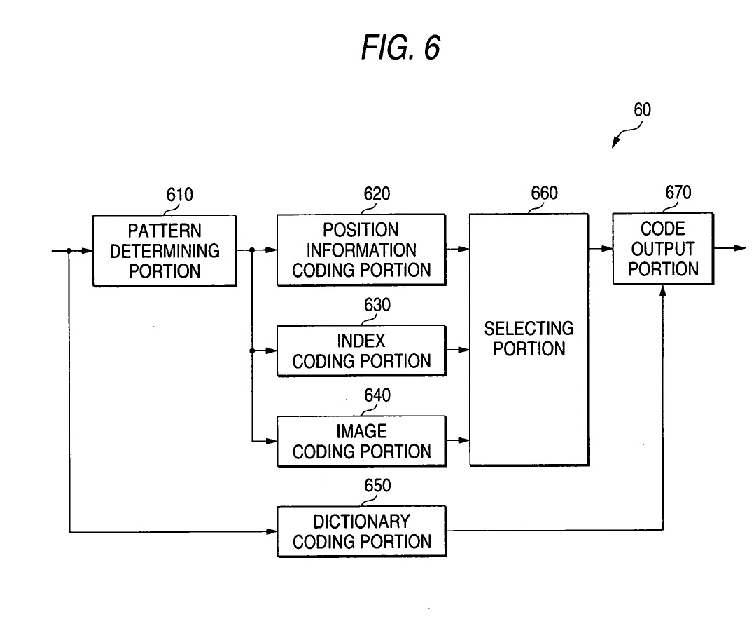

FIG. 6 describes the functions of the coding portion 60 in greater detail.

As shown in FIG. 6, the coding portion 60 includes a pattern determining portion 610 (a replacing unit), a position information coding portion 620, an index coding portion 630, an image coding portion 640, a dictionary coding portion 650, a selecting portion 660, and a code output portion 670.

The pattern determining portion 610 compares image patterns registered on the image dictionary and partial images contained in the input image and determines image patterns corresponding to the partial images (identical or similar image patterns). In detail, the pattern determining portion 610 overlaps the partial images (corrected by the position correcting portion 550) cutout of the input image on a character image basis and the image patterns, calculates the levels of coincidence by the same method as that of the coincidence determining portion 530 (FIG. 5), and determines whether or not these correspond to each other based on whether or not the calculated levels of coincidence are equal to or more than a reference value.

When a corresponding image pattern is found, the pattern determining portion 610 outputs position information of the partial image to the position information coding portion 620 and outputs the indexes of this image pattern to the index coding portion 630, and when no corresponding image pattern is found, the pattern determining portion outputs the partial images to the image coding portion 640.

The pattern determining portion 610 applies image patterns each corresponding to a character string more preferentially than the image patterns each corresponding to a single character, and for example, when a plurality of partial images serially coincide with the image patterns each corresponding to a single character and these partial images also coincide with an image pattern corresponding to a character string, the pattern determining portion outputs the index of the image pattern corresponding to a character string to the index coding portion 630, and outputs position information obtained when the plurality of partial images are determined as one partial image to the position information coding portion 620.

The position information coding portion 620 codes partial images inputted from the pattern determining portion 610 (i.e., position information (of character images or character string images) corrected by the position correcting portion 550), and outputs these to the selecting portion 660. For example, the position information coding portion 620 codes position information by applying LZ coding or arithmetic coding.

The index coding portion 630 codes indexes inputted from the pattern determining portion 610 and outputs these to the selecting portion 660. For example, the index coding portion 630 provides respective indexes with codes with different code lengths depending on the appearance frequencies of the indexes.

The image coding portion 640 applies a coding method suitable for the images to code partial images inputted from the pattern determining portion 610 and outputs these to the selecting portion 660.

The dictionary coding portion 650 codes an image dictionary (containing image patterns and indexes associated with each other) inputted from the image dictionary creating portion 50 (FIG. 4, FIG. 5) and outputs these to the code output portion 670.

The selecting portion 660 outputs the coded data of the position information inputted from the position information coding portion 620 and the coded data of the indexes inputted from the index coding portion 630 to the code output portion 670 by associating these with each other when an image pattern corresponding to the partial images is found by the pattern determining portion 610, and outputs the coded data of the partial images coded by the image coding portion 640 to the code output portion 670 when an image pattern corresponding to the partial images is not found by the pattern determining portion 610.

The code output portion 670 outputs the coded data (the position information, the indexes, and coded data of the partial images) and coded data (coded data of the image dictionary) inputted from the dictionary coding portion 650 to the printer 10 (FIG. 3), a storage device 22 (FIG. 3), or a communications device 22 (FIG. 3) by associating these with each other.

Next, the entire operations of coding by the image processing apparatus 2 are described.

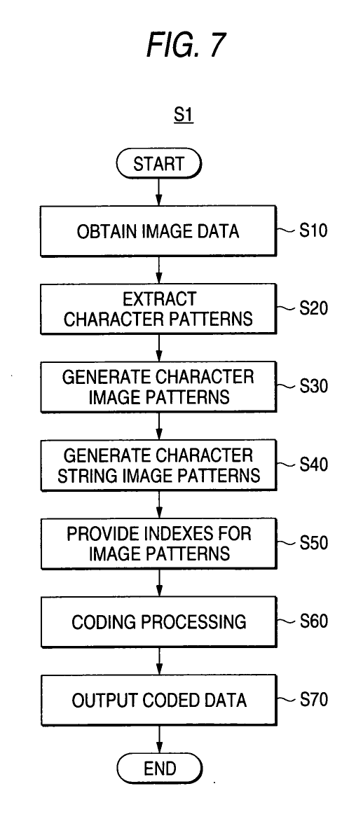

FIG. 7 is a flowchart showing the operations (S1) of the coding program 5. In this flowchart, a case where binary image data optically read by the scanner function of the printer 10 is inputted is explained as a detailed example.

As shown in FIG. 7, in Step 10 (S10), when an image data (binary) is inputted from the printer 10 (FIG. 3), the image input portion 40 outputs the inputted image data (input image) to the image dictionary creating portion 50. The character recognizing portion 410 (FIG. 4) of the image input portion 40 applies character recognition processing to the input image, determines character codes and position information of character images contained in the input image, and outputs the determined character codes and position information to the image dictionary creating portion 50. In this example, the combination of the starting position (the most upstream position of scanning) and the ending position (the most downstream position of scanning) of a character image is described as a detailed example of the position information.

In Step 20 (S20), the storage portion 500 of the image dictionary creating portion 50 stores the input image inputted from the image input portion 40, the character codes, and the position information (starting positions and ending positions) in the memory 204 (FIG. 3).

The character image extracting portion 510 specifies the ranges of character images in the input image based on the position information (starting positions and ending positions) stored by the storage portion 500, and cuts character images from specified ranges and stores these in the storage portion 500. Cutting-out of the character images is carried out from the whole of the input image (for example, one page or one document) to be coded.

In Step 30 (S30), the character classifying portion 520, the coincidence determining portion 530, the character dictionary determining portion 540, and the position correcting portion 550 classify character images extracted by the character image extracting portion 510 by character codes inputted from the character recognizing portion 410 (FIG. 4) in conjunction with each other, and determine image patterns to be registered on the image dictionary based on the classified character images, and stores the patterns in the storage portion 500 as an image dictionary.

In Step 40 (S40), the character string selecting portion 535 and the character string dictionary determining portion 545 select character strings to be registered as image patterns on the image dictionary in conjunction with each other and store images of selected character strings as image patterns in the storage portion 500.

In Step 50 (S50), the index assigning portion 560 provides the determined image patterns (image patterns each corresponding to a single character and image patterns each corresponding to a character string) with indexes, and stores these by associating the assigned indexes with the image patterns. The assigned indexes are for identifying the image patterns uniquely of at least the entire input image inputted as a coding target.

When determination of image patterns and provision of indexes are finished for the entire input image inputted as a coding target, the image patterns and indexes are outputted as an image dictionary to the coding portion 60.

In Step 60 (S60), the coding portion 60 compares the image patterns registered on the image dictionary and partial images contained in the input image, and when an image pattern coincident with the image pattern exists, replaces the partial image with an index and position information (only the starting position) to code the partial image, and codes a partial image that is not coincident with the image patterns without change. Furthermore, the coding portion 60 codes the image dictionary.

In Step 70 (S70), the coding portion 60 outputs the index, position information (only the starting position), and the coded data of the partial images and the coded data of the image dictionary to the printer 10 or the like.

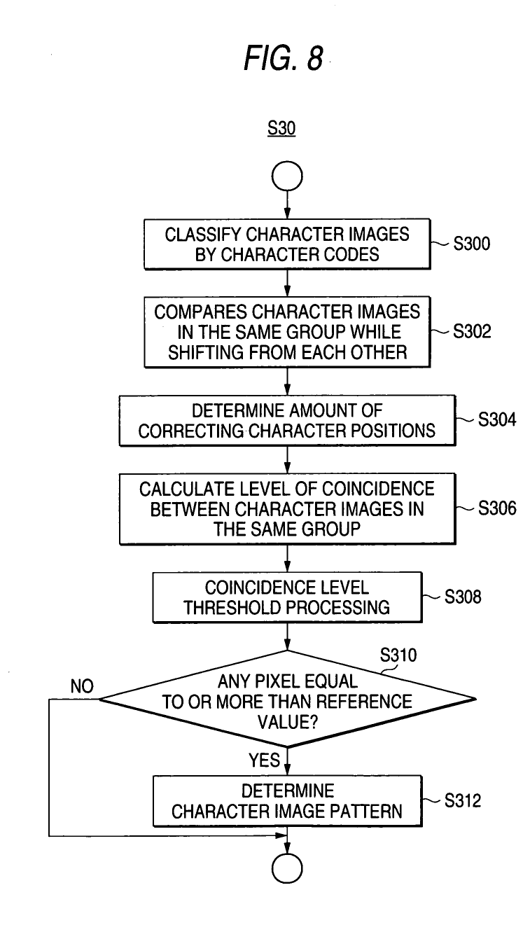

FIG. 8 is a flowchart describing the single-character corresponding image pattern determination processing (S30) in greater detail.

As shown in FIG. 8, in Step 300 (S300), the character classifying portion 520 classifies the character images extracted by the character image extracting portion 510 by the character codes inputted from the character recognizing portion 410 (FIG. 4).

In Step 302 (S302), the coincidence determining portion 530 compares the character images classified by the character codes with each other and determines the levels of coincidence at a plurality of relative positions. Concretely, the coincidence determining portion 530 prepares the pixel distribution (histogram) of black pixels in the character image group and calculates a coinciding pixel number of black pixels while shifting the prepared pixel distribution and the character images included in this character image group from each other. The pixel distribution is a histogram showing sums of pixel values of black pixels of the character images belonging to the character image group for each area at relative positions at which the coinciding pixel number becomes highest.

Namely, when the pixel distribution of the character image group is defined as Q(x), the pixel value of each character image is defined as P(i,x), the position vector is defined as x, each character image belonging to the character image group is defined as i (1 through N, N is the number of character images belonging to the character image group), and the shifting vector of the character image i is defined as vi, the coincidence determining portion 530 calculates the coinciding pixel number by the following expressions.
(coinciding pixel number K)=Σ{Q(x)*P(i, x−vi)}
(“Σx” shows the sum of variables x) ,where,
Q(x)=P(1, x), when i=1, and
   Q(x)=P(1, x)+P(2, x−v2)+ . . . +P(i−1, x−v(i−1)), when i>1

In Step 304 (S304), the position correcting portion 550 determines a correction vector for the position information inputted from the character recognizing portion 410 based on the coinciding pixel numbers (levels of coincidence) calculated at a plurality of relative positions by the coincidence determining portion 530. In detail, the position correcting portion 550 sets the shifting vector vi obtained when the coinciding pixel number K calculated by the coincidence determining portion 530 becomes largest (two-dimensional vector of shifting the character images based on the position information inputted from the character recognizing portion 410) as a correction vector.

In Step 306 (S306), the coincidence determining portion 530 compares the plurality of character images (the positions of which were corrected by the correction vector) classified into the same character image group and calculates the level of coincidence in pixel values in each area. In detail, the coincidence determining portion 530 overlaps all the character images included in the character image group at the relative positions at which the coincidence pixel number becomes largest and creates a pixel distribution (histogram) by summing the black pixels in the respective areas. Namely, the coincidence determining portion 530 calculates Q(x) for all character images (1 through N) included in each character image group by the following expression.
Q(x)=ΣP(i, x−vi)

In Step 308 (S308), the character dictionary determining portion 540 applies threshold processing to remove distribution numbers equal to or lower than the threshold to the levels of coincidence (pixel distribution) calculated by the coincidence determining portion 530. Concretely, the character dictionary determining portion 540 normalizes Q(x) calculated by the coincidence determining portion 530 to calculate Q′(x), and applies threshold processing to the calculated Q′(x). Namely, the character dictionary determining portion 540 calculates the distribution probability Q′(x) by the following expression.
Q′(x)=Q(x)/N
Next, by the following conditional formula, the coincidence determining portion 530 calculates Q″ (x) by removing the portion of the distribution probability Q′(x) smaller than the reference value.
Q″(x)=1 when Q′(x)>threshold A
In other cases, Q″(x)=0

In Step 310 (S310), the character dictionary determining portion 540 determines whether or not the area with a distribution number that is not zero in the pixel distribution after being subjected to threshold processing is broader than the reference, and when the area is equal to or more than the reference, the process changes to the processing of S312, and when the area is narrower than the reference, the image pattern determination processing (S30) is ended without registration of the image patterns for this character image group.

In detail, the character dictionary determining portion 540 determines whether or not the pixel number with which the above-mentioned Q″(x) becomes 1 is equal to or more than the reference value, and when it is equal to or more than the reference value, image pattern registration is carried out, and when it is smaller than the reference value, image pattern registration is not carried out.

In Step 312 (S312), the character dictionary determining portion 540 determines an image pattern based on the pixel distribution. In detail, the character dictionary determining portion 540 determines the pattern of Q″ (x) as an image pattern (image pattern corresponding to a single character) to be registered on the image dictionary, and stores it in the storage portion 500 as an image dictionary.

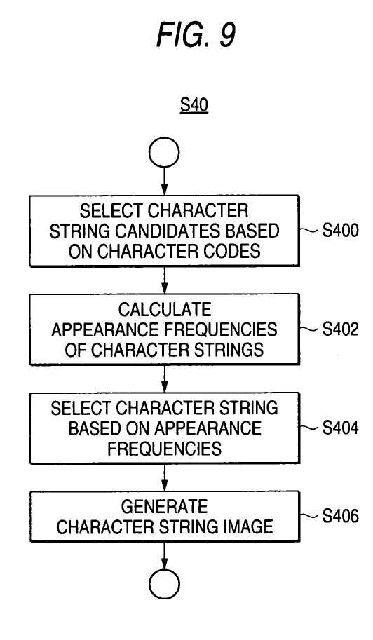

FIG. 9 is a flowchart describing the image pattern determination processing (S40) corresponding to a character string in greater detail.

As shown in FIG. 9, in Step 400 (S400), the character string selecting portion 535 determines a combination of characters as a character string candidate based on the character codes successively inputted from the character recognizing portion 410. In this example, a character string composed of two characters is described as a detailed example of the character string candidate.

In detail, the character string selecting portion 535 determines a combination of two character codes adjacent to each other in order of inputting as a character string candidate.

In Step 402 (S402), the character string selecting portion 535 counts the appearance frequency of the character string candidate in the entire input image (the whole page, the whole document or job) as a coding target. In detail, the character string selecting portion 535 counts the number of times of appearance adjacent to each other of a combination of character codes determined as a character string candidate, in the character codes aligned in order of inputting.

In Step 404 (S404), the character string selecting portion 535 selects character strings to be registered on the image dictionary among the character string candidates based on the counted appearance frequencies. In detail, the character string selecting portion 535 sets a threshold for the appearance frequencies, and selects character string candidates with appearance frequencies equal to or more than the threshold as character strings to be registered on the image dictionary.

In Step 406 (S406), the character dictionary determining portion 545 generates images of character strings selected by the character string selecting portion 535, and stores the generated character string images as an image dictionary in the storage portion 500. Concretely, the character string dictionary determining portion 545 reads image patterns (each corresponding to a single character) with character codes identical to those of the characters composing the selected character string from the image dictionary, and the readout image patterns are composited to generate an image pattern of the character string image. When a plurality of image patterns (each corresponding to a single character) are composited, based on position information (corrected by the position correcting portion 550) of the respective characters composing the character string, the relative positions of the image patterns to be composited are determined.

In this example, the character string selecting portion 535 selects a combination of characters adjacent to each other based on the order of character codes to be inputted, however, the invention is not limited to this, and for example, a combination of characters adjacent to each other may be selected based on the position information (position information inputted from the character recognizing portion 410) of characters.

Even when the character string candidates have the same combination of character codes, if they are determined as different in spacing between character images adjacent to each other based on the position information of characters (for example, “ab” and “a b”), the candidates are selected as different character string candidates, and the appearance frequencies of the respective character string candidates may be calculated.

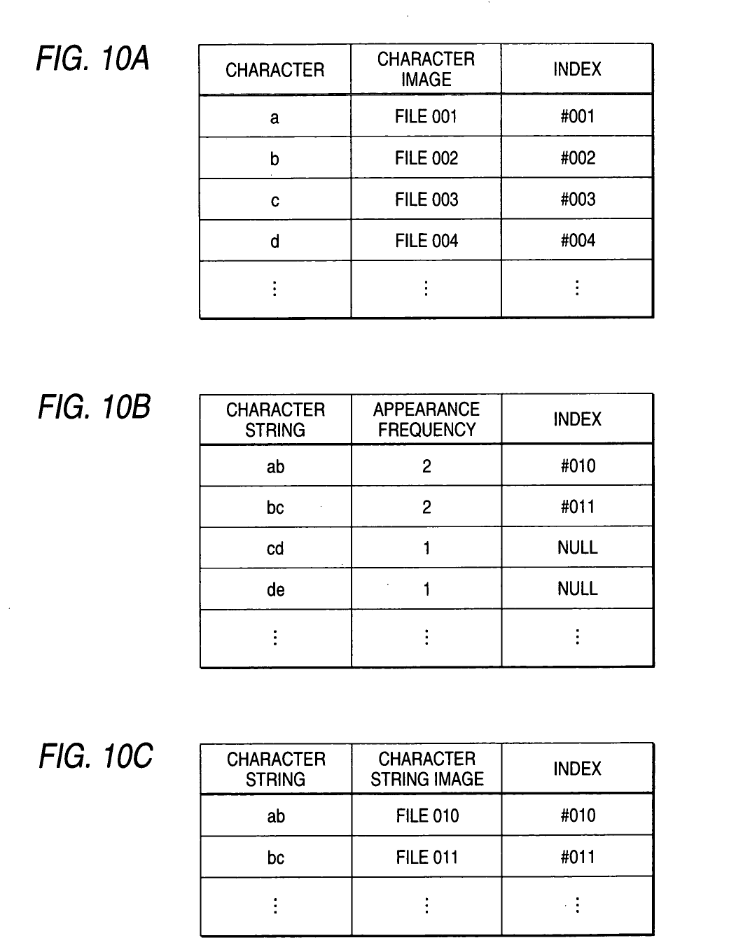

FIG. 10A illustrates an image dictionary of character images (a single character), FIG. 10B illustrates character string candidates and appearance frequencies, and FIG. 10C illustrates an image dictionary of character string images created based on the character string candidates.

As illustrated in FIG. 1A, the image dictionary creating portion 50 creates an image dictionary (first image dictionary data) in which character codes, data file of image patterns (character images) generated based on the character image groups of the character codes, and indexes assigned for the image patterns are associated with each other in the processing of S30 shown in FIG. 7. Namely, the character dictionary determining portion 540 creates a data file of an image pattern indicated as “file 001” based on the character image group classified by the character code corresponding to the alphabet “a.” The index assigning portion 560 provides indexes (serial numbers or the like) so that the created image patterns can be identified uniquely within a page, document, or job in S50 shown in FIG. 7.

Furthermore, as illustrated in FIG. 10B, the image dictionary creating portion 50 selects character string candidates composed of characters adjacent to each other in the processing of S40 shown in FIG. 7 and calculates the appearance frequencies of the selected character string candidates (within a page, document, or job), and selects character string candidates with the calculated appearance frequencies equal to or more than the threshold (“2” in this example) as character strings to be registered on the image dictionary. The selected character strings are assigned with indexes by the index assigning portion 560 in S50 shown in FIG. 7.

As illustrated in FIG. 10C, the image dictionary creating portion 50 creates the image dictionary (second image dictionary data) of character string images by excluding character string candidates with appearance frequencies smaller than the threshold (“2” in this example). The character string images to be registered on the image dictionary are created in S406 of FIG. 9 based on the data files of character images (each corresponding to a single character) illustrated in FIG. 10A.

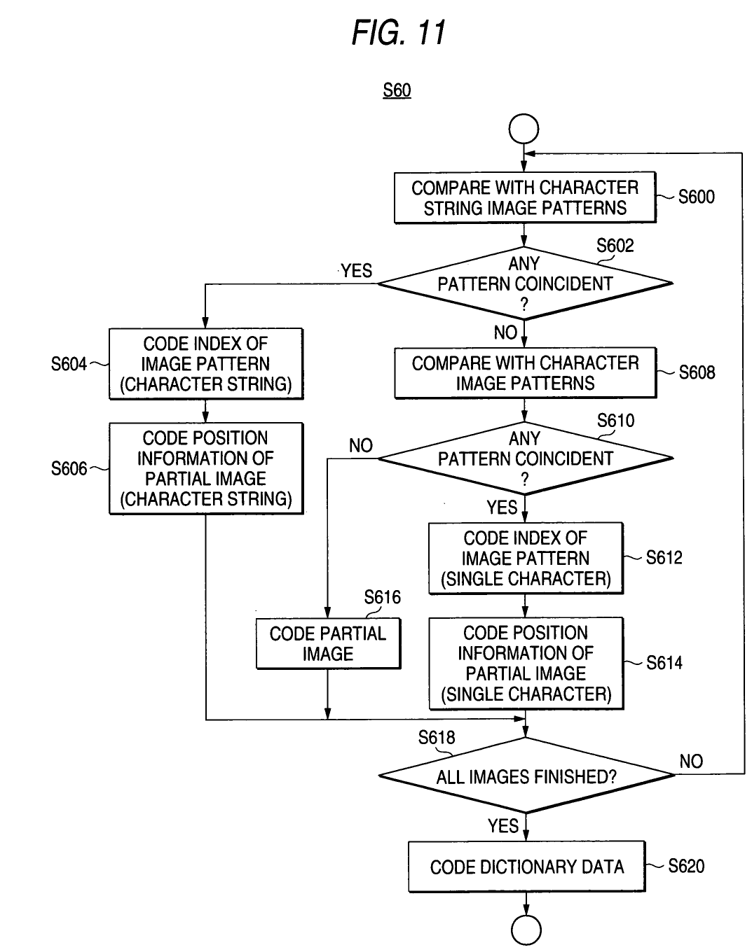

FIG. 11 is a flowchart describing coding processing (S60) in detail. In this flowchart, the case where coding is carried out based on the image patterns determined in FIG. 8 is described as a detailed example.

As shown in FIG. 11, in Step 600 (S600), the pattern determining portion 610 successively cuts partial images of two characters (character images of two characters) from the input image based on corrected position information, and compares the partial images of cut-out two characters with the image patterns of character string images registered on the image dictionary and calculates a coinciding pixel number. The pattern determining portion 610 may obtain the coinciding pixel number from the coincidence determining portion 530.

In Step 602 (S602), the pattern determining portion 610 determines whether coinciding image pattern is present. Specifically, the pattern determining portion 610 determines whether or not the coinciding pixel number calculated for each image pattern (character string) is within a permissible range (for example, 90% or more of all pixels of the partial images), and when it is within the permissible range, the process changes to the processing of S604, and when it is out of the permissible range, the process changes to the processing of S608.

In Step 604 (S604), the pattern determining portion 610 reads the index of an image pattern with the largest coinciding pixel number among the image patterns (character strings) with coinciding pixel numbers within the permissible range from the image dictionary, outputs the readout index to the index coding portion 630, and outputs position information of this character image (that is, the starting position of the partial images of two characters) to the position information coding portion 620.

The index coding portion 630 codes the index (character string) inputted from the pattern determining portion 610 and outputs the coded data of the index to the selecting portion 660.

In Step 606 (S606), the position information coding portion 620 codes the position information (the starting position of the partial images of the two characters) inputted from the pattern determining portion 610 and outputs the coded data of the position information to the selecting portion 660.

The selecting portion 660 outputs the coded data of the index (character string) inputted from the index coding portion 630 and the coded data of the position information (character string) inputted from the position information coding portion 620 to the code output portion 670 by associating these with each other. Namely, the selecting portion 660 outputs the index and the position information to the code output portion 670 so that these are associated with each other for each partial image.

In Step 608 (S608), the pattern determining portion 610 compares the first half of the partial images of cut-out two characters (that is, character image of a single character) with the image patterns (corresponding to a single character) of the character images registered on the image dictionary and calculates coinciding pixel numbers.

In Step 610 (S610), the pattern determining portion 610 determines whether or not the coinciding pixel numbers calculated for the respective image patterns (each corresponding to a single character) are within the permissible range (for example, 90% or more of all pixels of the partial images), and when it is within the permissible range, the process changes to the processing of S612, and when it is out of the permissible range, the process changes to the processing of S616.

In Step 612 (S612), the pattern determining portion 610 reads the index of the image pattern with the largest coinciding pixel number among the image patterns (each corresponding to a single character) with the coinciding pixel numbers within the permissible range from the image dictionary, outputs the readout index to the index coding portion 630, and outputs the position information (corrected by the position correcting portion 550) of this character image to the position information coding portion 620.

The index coding portion 630 codes the index (corresponding to a single character) inputted from the pattern determining portion 610 and outputs the coded data of the index to the selecting portion 660.

In Step 614 (S614), the position information coding portion 620 codes the position information (the starting position of the partial image) inputted from the pattern determining portion 610), and outputs the coded data of the position information to the selecting portion 660.

The selecting portion 660 outputs the coded data of the index (corresponding to a single character) inputted from the index coding portion 630 and the coded data of the position information inputted from the position information coding portion 620 to the code output portion 670 by associating these with each other.

In Step 616 (S616), the pattern determining portion 610 outputs the partial image (that is, character image corresponding to a single character which no image patterns in the image dictionary correspond to) to the image coding portion 640.

The image coding portion 640 codes the image data of the partial image (character image corresponding to a single character) inputted from the pattern determining portion 610, and outputs the coded data of the partial image to the selecting portion 660.

The selecting portion 660 outputs the coded data of the partial image inputted from the image coding portion 640 to the code output portion 670.

In Step 618 (S6.18), the pattern determining portion 610 determines whether or not coding has been finished for all the partial images, and when a partial image that has not been coded exists, the process returns to the processing of S602 and coding is carried out for the partial images of the next two characters, and when all the partial images are coded, the process changes to the processing of S614. Namely, after the pattern determining portion 610 replaces the partial images of cut-out two characters with image patterns of character string images to code these, partial images of the next two characters are cut out and subjected to processings of S600 and subsequent steps, and after a partial image corresponding to a single character of the partial images of the cut-out two characters is coded, the partial image of the other character and a partial image corresponding to a newly cut-out single character are subjected to the processings of S600 and subsequent steps.

In Step 620 (S620), the dictionary coding portion 650 codes the image dictionary (containing image patterns and indexes associated with each other) inputted from the image dictionary creating portion 50, and outputs the coded data of the image dictionary to the code output portion 670.

As described above, the image processing apparatus 2 of this embodiment carries out creation and coding of an image dictionary by using the results of character recognition processing, so that creation and coding of the image dictionary become easy. Furthermore, in this image processing apparatus 2, since an image dictionary is created on a character string basis and applied to coding processing, high coding efficiency (high compression rate) is realized.

Furthermore, this image processing apparatus 2 corrects the cutout positions of character images (position information of character images) by comparing character images belonging to the same character image group with each other, so that character image deviations caused by character image cutout errors or font differences are corrected, and layout of characters can be reproduced with high accuracy. Next, modified examples of the embodiment are described.

In the above-mentioned embodiment, the image dictionary creating portion 50 calculates the appearance frequencies of character strings in the whole input image as a coding target, and determines whether or not the character strings are to be registered as image patterns based on the calculated appearance frequencies. Therefore, the image dictionary creating portion 50 cannot register the image patterns of the character string images on the image dictionary until all the character images are cut out, and the coding portion 60 cannot start coding until the image dictionary is completed.

Therefore, in the image dictionary creating portion 50 of the first modified example, an image dictionary is successively created, and the coding portion 60 codes an input image based on the successively created image dictionary.

In detail, in the first modified example, the character image extracting portion 510 successively cuts character images out of an input image, and the coincidence determining portion 530 compares the successively cutout character images and registered image patterns and determines the levels of coincidence.

When the levels of coincidence between the registered image patterns and newly cutout character images (each corresponding to a single character) are all equal to or lower than the reference, the character dictionary determining portion 540 registers the character images on the image dictionary as image patterns, and otherwise the character dictionary determining portion 540 outputs the index of the image pattern with the highest level of coincidence to the coding portion 60 as a coding target.

The character string selecting portion 535 compares a combination of character codes of newly cutout character images (a character string containing newly cutout characters) and combinations of previously cutout character codes (previous character strings) to determine a coincidence length of the character strings, and when a coincidence length equal to or more than a reference value (for example, “2”) is determined, the character string selecting portion 535 selects this character string as a character string to be registered on the image dictionary. The character string dictionary determining portion 545 registers the image of the character string selected by the character string selecting portion 535 on the image dictionary as an image pattern. Determination on the coincidence length of the character strings is carried out by longest-match string searching that is applied in LZ coding, etc. When an identical character string is selected, the character string dictionary determining portion 545 excludes overlapping registration of this character string image.

The index assigning portion 560 provides indexes for the image patterns to be successively registered.

The coding portion 60 codes character images cut successively from the input image based on the image patterns successively registered on the image dictionary.

As described above, in the image processing apparatus 2 of the first modified example, an image dictionary is created successively, so that successive coding can be carried out.

Next, a second modified example will be described.

The accuracy (degree of certainty) of the character recognition by the character recognizing portion 410 may differ among character images contained in an input image. Therefore, even when an identical character string is determined based on the results of character recognition (character codes), the actual character image may be different.

Therefore, the image dictionary creating portion 50 of the second modified example classifies character strings contained in an input image according to the accuracies of character recognition, and selects character strings to be registered on the image dictionary according to the appearance frequencies of the character strings in each group.

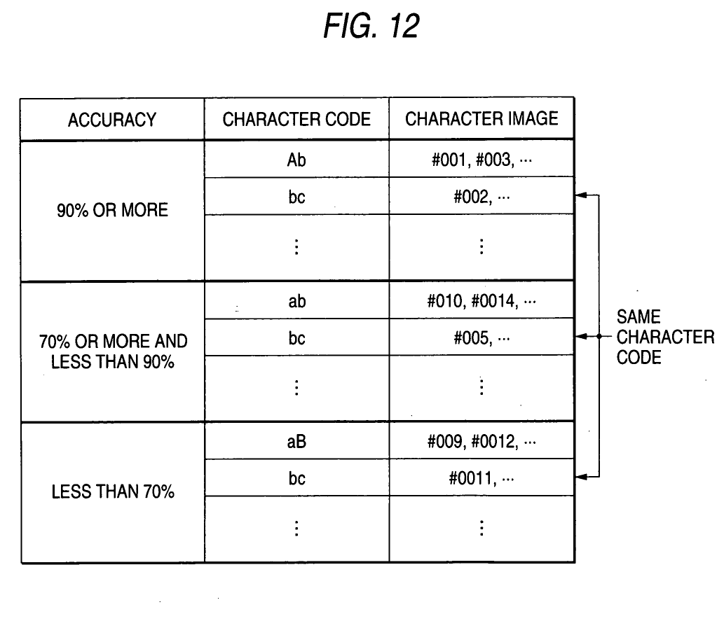

FIG. 12 illustrates an image dictionary created for each accuracy of character recognition.

As illustrated in FIG. 12, the character string selecting portion 535 of the second modified example obtains the accuracies of character recognition from the character recognizing portion 410, and classifies character strings contained in an input image according to the obtained accuracies. The character string selecting portion 535 of this example classifies character strings by accuracy ranges into character strings with “accuracy of 90% or more,” character strings with “accuracy of 70% or more and less than 90%,” and character strings with “accuracy of less than 70%”. The accuracy of a character string is calculated based on the accuracies of characters composing the character string, and is, for example, the average of accuracies of the characters or the product of accuracies of the characters.

The character string selecting portion 535 calculates the appearance frequencies of character strings for each character string group thus classified, and selects character strings to be registered on the image dictionary from each group based on the calculated appearance frequencies.

To determine an image pattern for a character string group with low accuracy, first, the character string dictionary determining portion 545 compares an image pattern determined for a character string group with high accuracy and character string images belonging to this character string group (character image group with low accuracy) to determine whether or not these are coincident with each other, and when these are coincident with each other, to exclude overlapping registration, the character string dictionary determining portion prohibits registration of an image pattern based on this character string image.

As described above, the image processing apparatus 2 of the second modified example can minimize the influence of character recognizing failures on the image dictionary by creating the image dictionary for each accuracy of character recognition.

[FIG. 1A]

a: Coding side
b: Decoding side
c: Character codes, font types, positions of occurrence, etc.
d: Coding methods applied different between characters and images
e: Font DB
f: Need to be associated with each other
   [FIG. 1B]
a: Coding side
b: Decoding side
c: Image dictionary, indexes, positions of occurrence, etc.
   [FIG. 2A]
a: Index
b: Image pattern (binary image)
c: File 001
d: File 002
   [FIG. 2C]
e: Redundancy (correlation)
   [FIG. 3]
26 UI device
22 Communications device
204 Memory
10 Printer
20 Control device
24 Recording device
240 Storage medium
   [FIG. 4]
a: From scanner
b: From storage device
40 Image input portion
410 Character recognizing portion
420 PDL decomposer
50 Image dictionary creating portion
60 Coding portion
c: To storage device
   [FIG. 5]
a: Character codes, character area information, input image data
510 Character image extracting portion
520 Character classifying portion
530 Coincidence determining portion
535 Character string selecting portion Storage portion 500
540 Character dictionary determining portion
545 Character string dictionary determining portion
550 Position correcting portion
560 Index assigning portion
b: Dictionary data, character area information (corrected),
input image data
   [FIG. 6]
610 Pattern determining portion
620 Position information coding portion
630 Index coding portion
Image coding portion
Dictionary coding portion
Selecting portion
Code output portion
   [FIG. 7]
a: Start
S10 Obtain image data
S20 Extract the character images
S30 Generate character image patterns
S40 Generate character string image patterns
S50 Provide indexes for image patterns
S60 Coding processing
S70 Output coded data
B: End
   [FIG. 8]
S300 Classify the character images by character codes
S302 Compares the character images in the same group while shifting from each other
S304 Determine the amount of correcting the character positions
S306 Calculates the level of coincidence between the character images in the same group
S308 Coincidence level threshold processing
S310 Any pixel equal to or more than the reference value?
S312 Determine a character image pattern
A: Character image pattern determination processing (S30)
   [FIG. 9]
S400 Select character string candidates based on character codes
S402 Calculates appearance frequencies of the character strings
S404 Select character string based on the appearance frequencies
S406 Generate character string image
a: Character string image pattern determination processing (S40)
   [FIG. 10A]
X1: Character
X2: Character image
X3: Index
X4: File 001
X5: File 002
X6: File 003

X7: File 004
X8: Image dictionary of character images
   [FIG. 10B]
Y1: Character string
Y2: Appearance frequency
Y3: Index
Y4: Character string candidates
   [FIG. 10C]
Z1: Character string
Z2: Character string image
Z3: Index
Z4: File 010
Z5: File 011
Z6: Image dictionary of character string images
   [FIG. 11]
S600 Compare with character string image patterns
S602 Any pattern coincident?
S608 Compare with character image patterns
S610 Any pattern coincident?
S616 Code the partial image
S612 Code the index of the image pattern (single character)
S614 Code the position information of the partial image (single character)
S604 Code the index of the image pattern (character string)
S606 Code the position information of the partial image (character string)
S618 All images finished?
S620 Code the dictionary data
A: Coding processing (S60)
   [FIG. 12]
X1: Accuracy
X2: Character code
X3: Character image
X4: 90% or more
X5: 70% or more and less than 90%
X6: Less than 70%
X7: The same character code

1. An image dictionary creating apparatus, comprising:
an information obtaining unit that obtains results of character recognition processing for an input image;
a character string selection unit that selects character strings adjacent to each other in the input image based on the results of character recognition obtained by the information obtaining unit;
a typical pattern determining unit that determines typical image patterns composing the input image on the basis of the images of character strings selected by the character string selection unit; and
an identification information assigning unit that assigns the respective determined image patterns determined by the typical pattern determining unit with identification information for identifying image patterns.

2. The image dictionary creating apparatus according to claim 1,
wherein the character string selection unit determines the appearance frequencies of character strings based on the results of character recognition obtained by the information obtaining unit and selects character strings according to the determined appearance frequencies.

3. The image dictionary creating apparatus according to claim 1, further comprising:
a pattern memory that stores single-character images as image patterns,
wherein the typical pattern determining unit reads character images composing character strings selected by the character string selection unit from the pattern memory, and determines image patterns of character strings on the basis of the readout image patterns.

4. The image dictionary creating apparatus according to claim 2, wherein
the information obtaining unit obtains at least character codes of respective character images as a result of the character recognition processing, and
the character string selection unit determines the appearance frequencies of character strings in the input image on the basis of the character codes obtained by the information obtaining unit.

5. The image dictionary creating apparatus according to claim 3, further comprising: a character classification unit;
wherein the information obtaining unit obtains at least character codes of respective character images as a result of character recognition processing;
the character classification unit which classifies character images contained in the input image into a plurality of character image groups on the basis of the character codes obtained by the information obtaining unit; and
the typical pattern determining unit determines single-character corresponding image patterns based on character images classified into the character image groups by the character classification unit, and stores the determined image patterns in the pattern memory.

6. The image dictionary creating apparatus according to claim 1, wherein
the information obtaining unit obtains character area information showing areas of character images in the input image as a result of character recognition processing; and
the character string selection unit selects character strings adjacent to each other in the input image based on the character area information obtained by the information obtaining unit.

7. A coding apparatus, comprising:
a replacement unit that replaces character images or character string images with identification information and character area information, the character images or character string images contained in an input image, the identification information corresponding to the character images or the character string images, the character area information showing areas of the character images or the character string images, on the basis of an image dictionary which associates the character images and character string images contained in the input image and the identification information;
a code outputting unit that outputs the identification information, the character area information replaced by the replacement unit and the image dictionary.

8. The coding apparatus according to claim 7, further comprising:
an information obtaining unit that obtains results of character recognition processing for an input image;
a character string selection unit that selects character strings adjacent to each other in the input image based on the results of character recognition obtained by the information obtaining unit;
a typical pattern determining unit that determines typical image patterns composing the input image based on the images of the character strings selected by the character string selection unit; and
an identification information assigning unit that assigns identification information for identifying image patterns to the respective image patterns determined by the typical pattern determining unit;
wherein the replacement unit replaces the character images or character string images based on the image patterns and an identification information image dictionary assigned for the respective image patterns by the identification information assigning unit; and
the code outputting unit outputs an image dictionary outputted from the output unit and identification information and character area information replaced by the replacement unit.

9. A computer readable medium configured to store a data file, the data file comprising:
first image dictionary data containing data on character images each corresponding to a single character and first identification information for identifying this character image, the data on character images and the first identification information associated with each other;
second image dictionary data containing data on character string images corresponding to character strings and second identification information for identifying the character string images, the data on character string images and the second identification information associated with each other; and
coded data containing positions of occurrence of the character images or the character string images in the whole image and identification information corresponding to the character images or the character string images, the positions and the identification information associated with each other.

10. An image dictionary creating method, comprising:
obtaining results of character recognition processing for an input image;
selecting character strings adjacent to each other in the input image based on the obtained results of character recognition;
determining typical image patterns composing the input image based on the selected character string images; and
assigning identification information for identifying image patterns to the determined image patterns.

11. A computer readable medium configured to store a set of instructions for operating a computer in an image dictionary creating apparatus, the instructions comprising:
obtaining results of character recognition processing for an input image;
selecting character strings adjacent to each other in the input image based on the obtained results of character recognition;
determining typical image patterns composing the input image based on images of the selected character strings; and
providing the determined image patterns with identification information for identifying image patterns.
